(19) United States
(12) Patent Application Publication
(10) Pub. No.: US 2023/0113365 A1
(43) Pub. Date: Apr. 13, 2023

(54) ELECTRONIC CIGARETTE WORKING IN CONTACT-TYPE CONDUCTIVE MODE

(71) Applicant: Shenzhen Eigate Technology Co., Ltd., Shenzhen (CN)

(72) Inventor: Tuanfang LIU, Shenzhen (CN)

(21) Appl. No.: 17/695,878

(22) Filed: Mar. 16, 2022

(30) Foreign Application Priority Data
Oct. 8, 2021 (CN) 202111173360.8
Oct. 8, 2021 (CN) 202122421063.2

(51) Int. Cl. A24F 40/40; A24F 40/57; A24F 40/90; A24F 40/10

(52) U.S. Cl. CPC A24F 40/40; A24F 40/57; A24F 40/90; A24F 40/10

(57) ABSTRACT

An electronic cigarette includes an atomization assembly. The atomization assembly comprises an electric heating element, a first conductive electrode, a second conductive electrode, and a circuit control board configured to control the electric heating element to work. The electric heating element is electrically connected to the first conductive electrode and the second conductive electrode through the circuit control board.

### CROSS-REFERENCE TO RELATED APPLICATIONS

Pursuant to 35 U.S.C.§ 119 and the Paris Convention Treaty, this application claims foreign priority to Chinese Patent Application No. 202111173360.8 filed Oct. 8, 2021, and to Chinese Patent Application No. 202122421063.2 filed Oct. 8, 2021. The contents of all of the aforementioned applications, including any intervening amendments thereto, are incorporated herein by reference. Inquiries from the public to applicants or assignees concerning this document or the related applications should be directed to: Matthias Scholl P. C., Attn. Dr. Matthias Scholl Esq., 245 First Street, 18th Floor, Cambridge, Mass. 02142.

### BACKGROUND

The disclosure relates to an electronic cigarette working in a contact-type conductive mode.

The circuit control board of conventional e-cigarettes is electrically soldered to positive and negative electrodes. The electric heating element is electrically soldered to the circuit control board, or is soldered to the conductive electrodes, and then electrically connected to the circuit control board. This kind of electrical connection involves complex soldering processes and complex assembly process of e-cigarettes, resulting in low production efficiency and high labor cost.

### SUMMARY

The disclosure also provides an electronic cigarette working in a contact-type conductive mode.

The following advantages are associated with the electronic cigarette of the disclosure: the circuit control board of the electronic cigarette is disposed in the atomization assembly instead of the battery assembly. Conventionally, the electric heating element is soldered to the first conductive electrode and the second conductive electrode. In this disclosure, the electric heating element is directly soldered to the circuit control board. Thus, the soldering process between the battery assembly and the circuit control board is omitted, thus facilitating the assembly, improving the production efficiency, and saving the labor cost.

### BRIEF DESCRIPTION OF THE DRAWINGS

FIG. 1 is an exploded view of an electronic cigarette according to one embodiment of the disclosure;

FIG. 2 is a schematic diagram of an electronic cigarette according to one embodiment of the disclosure;

FIG. 3 is a sectional view of an electronic cigarette according to one embodiment of the disclosure; and

FIG. 4 is a current flow direction of an electronic cigarette according to one embodiment of the disclosure.

### DETAILED DESCRIPTION

To further illustrate the disclosure, embodiments detailing an electronic cigarette and an electronic cigarette of the disclosure are described below. It should be noted that the following embodiments are intended to describe and not to limit the disclosure.

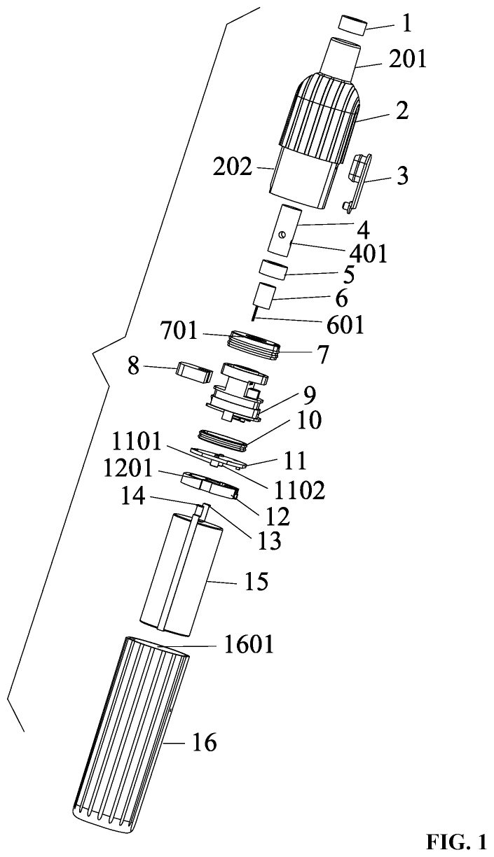

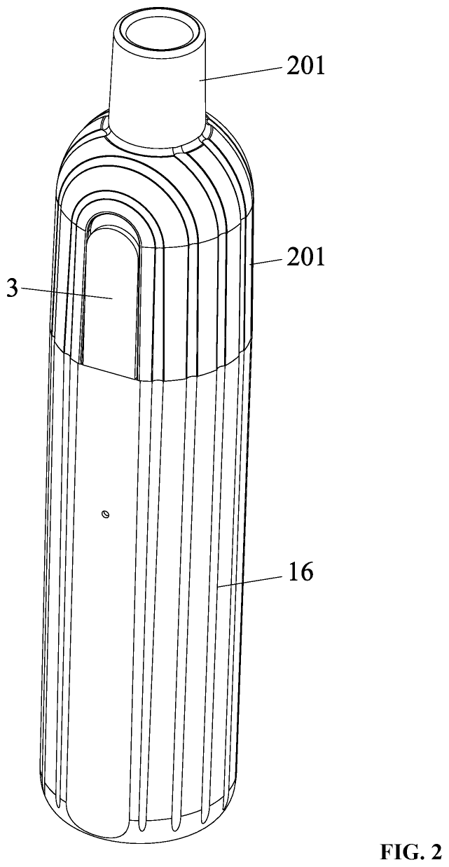

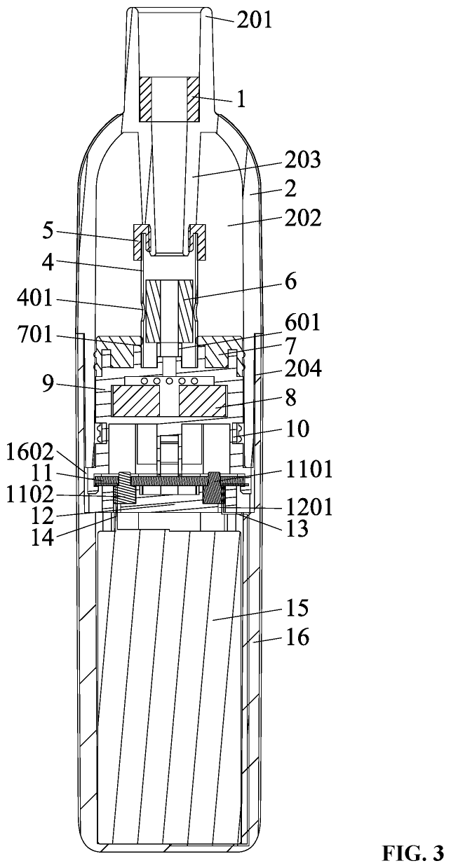

As shown in FIGS. 1-3, an electronic cigarette of the disclosure comprises an atomization assembly. The atomization assembly comprises an electric heating element 6, a first conductive electrode 1101, a second conductive electrode 1102, and a circuit control board 11 configured to control the electric heating element to work; and the electric heating element is electrically connected to the first conductive electrode 1101 and the second conductive electrode 1102 through the circuit control board 11. The electric heating element 6 is configured to heat and atomize the e-liquid. The first conductive electrode 1101 and the second conductive electrode 1102 are both made of conductive metal. The circuit control board 11 is disposed in the atomization assembly instead of the battery assembly. Conventionally, the electric heating element 6 is soldered to the first conductive electrode 1101 and the second conductive electrode 1102. In this example, the electric heating element 6 is directly soldered to the circuit control board 11. Thus, the soldering process between the battery assembly and the circuit control board 11 is omitted, thus facilitating the assembly, improving the production efficiency, and saving the labor cost.

In certain embodiments, the electric heating element 6 comprises a conductive pin 601; the conductive pin 601 is electrically connected to the circuit control board 11; the circuit control board 11 is disposed on the bottom of the atomization assembly; the first conductive electrode 1101 and the second conductive electrode 1102 are disposed on and electrically connected to the circuit control board 11. The electric heating element 6 and the conductive pin 601 are made of conductive metal. The conductive pin 601 is electrically connected to the circuit control board 11 by soldering, and the first conductive electrode 1101 and the second conductive electrode 1102 are directly disposed on the circuit control board 11, which saves the manual soldering process during assembly, facilitates assembly, and reduces process steps.

In certain embodiments, the atomization assembly comprises a base 9; the circuit control board 11 is disposed on the bottom side of the base 9; one side of the circuit control board 11 back against the base 9 is provided with an insulating cover plate 12; the insulating cover plate 12 comprises at least two first through holes 1201, and the first conductive electrode 1101 and the second conductive electrode 1102 are disposed in the at least two first through holes 1201, respectively. The first conductive electrode 1101 and the second conductive electrode 1102 are insulated from each other through the insulating cover plate 12.

In certain embodiments, the base 9 comprises a through hole; the conductive pin 601 of the electric heating element 6 extends through the through hole and is electrically connected to the circuit control board 11.

Specifically, the electric heating element 6 is electrically connected to the circuit on the circuit control board 11. The conductive pin 601 of the electric heating element 6 runs through the base 9 and is electrically connected to the circuit control board 11, which can save the conversion wire and soldering process of the circuit control board 11 and conductive pin 601.

In certain embodiments, the electronic cigarette further comprises a battery module; the battery module comprises a battery 15, a third conductive electrode 13, and a fourth conductive electrode 14; the battery comprises a first electrode and a second electrode; the third conductive electrode 13 and the fourth conductive electrode 14 are electrically connected to the first electrode and the second electrode, respectively; and the third conductive electrode 13 and the fourth conductive electrode 14 are respectively electrically connected to the first conductive electrode 1101 and the second conductive electrode 1102 in a contact manner. Optionally, the battery 15 is a cell. The first electrode and the second electrode refer to the positive and negative electrodes of the battery. The third conductive electrode 13 and the fourth conductive electrode 14 are made of conductive metal. During assembly, the third conductive electrode 13 and the fourth conductive electrode 14 are electrically connected in contact with the first conductive electrode 1101 and the second conductive electrode 1102, respectively, thus facilitating the assembly and reducing the soldering process.

In certain embodiments, the third conductive electrode 13 and the fourth conductive electrode 14 extends into corresponding first through holes 1201, respectively; and the third conductive electrode 13 and the fourth conductive electrode 14 are respectively electrically connected to the first conductive electrode 1101 and the second conductive electrode 1102 in the corresponding first through holes 1201 in a contact manner. The electrodes are isolated from each other through the first through holes 1201, which facilitates the assembly; the third conductive electrode 13 and the fourth conductive electrode 14 can be accurately aligned with the first conductive electrode 1101 and the second conductive electrode 1102 in the first through holes 1201. Understandably, the first through hole 1201 can be a conductive contact joint of the atomization assembly and the battery assembly, which can not only save the soldering connection operation, but also separate the atomizer and the cartridge.

In certain embodiments, one end of the third conductive electrode 13 is electrically connected to the first electrode of the battery 15, and the third conductive electrode 13 extends along the outer wall of the battery to the top of the battery 15 and enters one of the first through holes 1201; one end of the fourth conductive electrode 14 is electrically connected to the second electrode of the battery, and the fourth conductive electrode 14 extends out of the top of the battery and enters another first through hole; the third conductive electrode 13 and the fourth conductive electrode 14 are both electrode sheets or electrode columns in a bent shape, and the third conductive electrode 13 and the fourth conductive electrode 14 are respectively electrically connected to the first electrode and the second electrode in a contact manner or in a soldering manner. The first electrode is disposed on the bottom of the battery 15, and the second electrode is disposed on the top of the battery 15.

The third conductive electrode 13 and the fourth conductive electrode 14 are made of conductive metal, and may be an electrode sheet or an electrode column. The first electrode and the second electrode of the battery 15 do not need to be soldered with the third conductive electrode 13 and the fourth conductive electrode 14. The third conductive electrode 13 and the fourth conductive electrode 14 are fixed relative to the battery 15 through the first through holes 1201, and the third conductive electrode 13 and the fourth conductive electrode 14 can be bent, such as L-shaped. One end of the third conductive electrode 13 and one end of the fourth conductive electrode 14 is in contact with the first electrode and the second electrode respectively, and the other ends thereof are fixed in the first through holes 1201. Further, the third conductive electrode 13 and the fourth conductive electrode 14 can be relatively fixed through an external housing 16.

In certain embodiments, the battery module comprises a housing 16, and the battery 15 is disposed in the housing 16; the housing 16 comprises a cavity 1602 above the battery 15; one end of the housing is provided with an opening 1601 communicating with the cavity 1602; the third conductive electrode 13 and the fourth conductive electrode 14 extend into the cavity 1602, and the bottom of the atomization assembly is disposed in the cavity 1602. Upon assembling, the bottom end of the atomization assembly is inserted into the cavity 1602, the third conductive electrode 13 and the fourth conductive electrode 14 are inserted into the corresponding first through holes 1201, and then electrically connected to the first conductive electrode 1101 and the second conductive electrode 1102.

In certain embodiments, the atomization assembly comprises an e-liquid storage element 2, a mouthpiece 201, and a smoke tube 203; the mouthpiece 201 comprises an inhaling hole; the e-liquid storage element 2 comprises an e-liquid chamber 202; the e-liquid in the e-liquid chamber 202 flows to the electric heating element via an e-liquid inlet 401; and one end of the smoke tube 203 is connected to the mouthpiece 201 and the other end extends to communicate with the electric heating element 6. The e-liquid is guided from the e-liquid chamber 202 to the electric heating element 6 through the e-liquid inlet 401. The electric heating element 6 heats and atomizes the e-liquid, and the generated smoke or vapor flows out of the smoke tube 203 and the inhaling hole. For example, one end of the e-liquid storage element 2 shrinks and extends axially to form the mouthpiece 201 for smoking, and a piece of cotton 1 for absorbing condensed e-liquid is disposed in the cavity of the mouthpiece 201. The atomization assembly comprises an atomization tube 4; one end of the atomization tube 4 is connected to the smoke tube 203, and the e-liquid chamber 202 surrounds the outer circumference of the smoke tube 203 and the atomization tube 4. The other end of the e-liquid storage element 2 shrinks and extends along the axial direction to form an assistant part 204 integrated with the e-liquid storage element 2. The outer peripheral wall of the assistant part 204 matches the inner peripheral wall and the height of the cavity 1602 below the opening 1601, so that the connection between the atomization assembly and the battery assembly is more stable, and the conductive contact position therebetween is more stable, and there will be no poor contact.

In certain embodiments, the electric heating element 6 comprises an e-liquid guide configured to guide the e-liquid from the e-liquid inlet 401 to the electric heating element 6. The e-liquid guide is made of e-liquid absorbing cotton, e-liquid absorbing fiber, e-liquid absorbing ceramic, e-liquid absorbing mica, e-liquid absorbing resin, etc.

In certain embodiments, the e-liquid storage element 2 comprises a sealing element 7 to seal the e-liquid chamber 202; and the base 9 is disposed on one side of the sealing element back against the e-liquid chamber 202. A part of the e-liquid storage element 2 and the base 9 are inserted into the cavity 1602 of the battery assembly.

In certain embodiments, the sealing element 7 comprises a second through hole 701. One end of the atomization tube 4 is inserted into the second through hole 701 and sealed therein. Understandably, one end of the atomization tube 4 is sealed in the second through hole 701 so that the e-liquid is isolated, thus preventing the short circuit due to the contact between the e-liquid and the conductive pin 601.

In certain embodiments, the e-liquid guide is a ceramic tube; the electric heating element 6 is disposed in the ceramic tube; one end of the ceramic tube communicates with the smoke tube 203. The atomization assembly comprises an air inlet channel, the other end of the ceramic tube communicates with the air inlet channel, and the e-liquid inlet 401 is disposed on the ceramic tube. Or, the e-liquid guide is a piece of cotton or a fiber, and the electric heating element 6 is placed in the piece of cotton or the fiber; the atomization assembly comprises the atomization tube 4; the atomization tube 4 is made of any material, and the e-liquid inlet 401 is disposed on the atomization tube 4; one end of the atomization tube 4 is connected to the smoke tube 203, and the other end of the atomization tube 4 is connected to the air inlet channel; the piece of cotton or the fiber is placed in the atomization tube 4 and is opposite to the e-liquid inlet 401. Or, the e-liquid guide is a piece of cotton or a fiber, and the electric heating element 6 is wrapped around the piece of cotton or the fiber; the smoke tube 203 directly extends to connect to the piece of cotton and the electric heating element 6; the e-liquid inlet 401 is disposed on the seal 7, and the electric heating element 6 and the cotton or the fiber are disposed on one side of the seal 7 back against the e-liquid chamber 202.

Specifically, as shown in FIGS. 1-3, the electronic cigarette of the disclosure comprises a piece of cotton 1, an e-liquid storage element 2, a seal plug 3, an atomization tube 4, a sealing sleeve 5, an electric heating element 6, a sealing element 7, an e-liquid absorber 8, a base 9, a seal ring 10, a circuit control board 11, an insulating cover plate 12, a third conductive electrode 13, a fourth conductive electrode 14, a battery 15, and a housing 16. The e-liquid storage element 2 comprises an e-liquid chamber 202 for storing e-liquid. The atomization tube 4 is disposed in the e-liquid chamber 202. The outer wall of the atomization tube 4 comprises a plurality of e-liquid inlets 401 through which the e-liquid enters the atomization tube. The electric heating element 6 is disposed in the atomization tube 4 to heat the e-liquid. The conductive pin 601 of the electric heating element 6 extends out of the bottom of the atomization tube 4 so that the conductive pin 601 is directly electrically connected to the circuit control board 11. One end of the e-liquid storage element 2 shrinks and extends axially to form a mouthpiece 201 for smoking, and the piece of cotton 1 is disposed in the cavity of the mouthpiece 201 for absorbing condensed e-liquid. One end of the mouthpiece 201 extends towards the e-liquid chamber 202 to form a smoke tube 203. The smoke tube 203 communicates with the atomization tube 4 for the flow of the smoke or vapor. The e-liquid chamber 202 surrounds the outer circumference of the smoke tube 203 and the atomization tube 4. The other end of the e-liquid storage element 2 shrinks and extends along the axial direction to form an assistant part 204 integrated with the e-liquid storage element 2. The sealing element 7 is disposed in the e-liquid storage element 2 to seal the e-liquid chamber 202. The sealing element 7 comprises a second through hole 701. One end of the atomization tube 4 is inserted into the second through hole 701 and sealed therein. Understandably, one end of the atomization tube 4 is sealed in the second through hole 701 so that the e-liquid is isolated, thus preventing the short circuit due to the contact between the e-liquid and the conductive pin 601. The e-liquid absorber 8 is disposed around the base 9 to absorb leaked e-liquid. The base 9 is disposed in the e-liquid storage element 2 and below the sealing element 7 to fix the sealing element 7. The circuit control board 11 is disposed on the bottom of the base 9 to control the operation of the electric heating element 6. The conductive pin 601 of the electric heating element 6 passes through the upper end of the base 9 and is soldered to the circuit control board 11 so that the circuit control board 11 supplies power to the electric heating element 6 through the conductive pin 601. The circuit control board 11 comprises a first conductive electrode 1101 and a second conductive electrode 1102. The insulating cover plate 12 is disposed below the circuit control board 11 and fixed on the bottom of the base 9 for isolation. The insulating cover plate 12 comprises two first through holes 1201. The first conductive electrode 1101 and the second conductive electrode 1102 are respectively located in the corresponding first through holes 1201 for electric conduction. The upper end of the housing 16 comprises an opening 1601, and a cavity 1602 is formed in the body of the housing and communicates with the opening 1601. The upper and lower ends of the battery 15 are respectively connected to a third conductive electrode 13 and a fourth conductive electrode 14 for electric conduction. The battery 15 is disposed in the cavity 1602 in the body of the housing and communicating with the opening 1601. One end of the third conductive electrode 13 extends from the first electrode at the upper end of the battery 15 to the cavity 1602, and one end of the fourth conductive electrode 14 extends from the second electrode at the lower end of the battery 15 to the cavity 1602. The assistant part 204 is inserted into the cavity 1602 from the opening 1601 of the housing 16, and the e-liquid storage element 2 is exposed. One end of the third conductive electrode 13 and one end of the fourth conductive electrode 14 located in the cavity 1602 are respectively inserted into the corresponding first through holes 1201 on the insulating cover plate 12 to contact the first conductive electrode 1101 and the second conductive electrode 1102 to realize electrical connection.

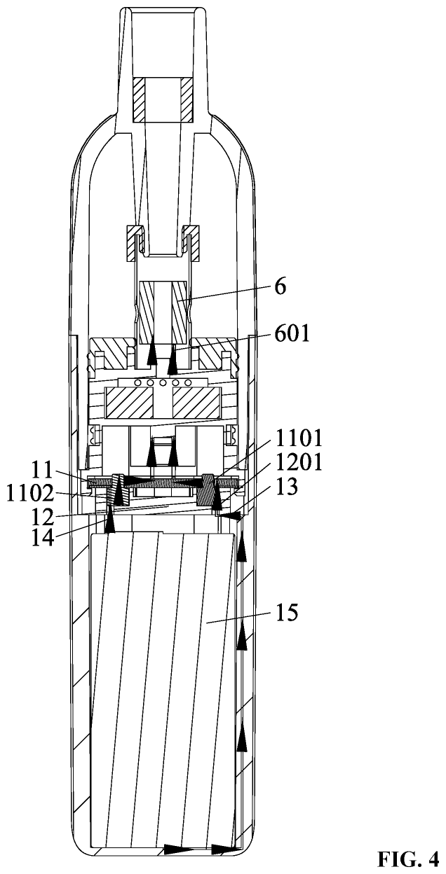

FIG. 4 is a current flow direction of the electronic cigarette of the disclosure. In the power on state, current is generated between the upper and lower ends of the battery 15. The current is transmitted to the first conductive electrode 1101 and the second conductive electrode 1102 on the circuit control board 11 through one end of the third conductive electrode 13 and one end of the fourth conductive electrode 14 respectively, and then the current is transmitted to the conductive pin 601 through the internal circuit of the circuit control board 11, and then is conducted to the electric heating element 6 through the conductive pin 601 to energize and heat the electric heating element.

It will be obvious to those skilled in the art that changes and modifications may be made, and therefore, the aim in the appended claims is to cover all such changes and modifications.

The invention claimed is:

1. An electronic cigarette, comprising an atomization assembly; wherein, the atomization assembly comprises an electric heating element, a first conductive electrode, a second conductive electrode, and a circuit control board configured to control the electric heating element to work; and the electric heating element is electrically connected to the first conductive electrode and the second conductive electrode through the circuit control board.

2. The electronic cigarette of claim 1, wherein the electric heating element comprises a conductive pin; the conductive pin is electrically connected to the circuit control board; the circuit control board is disposed on a bottom of the atomization assembly; the first conductive electrode and the second conductive electrode are disposed on and electrically connected to the circuit control board.

3. The electronic cigarette of claim 2, wherein the atomization assembly comprises a base; the circuit control board is disposed on a bottom side of the base; one side of the circuit control board back against the base is provided with an insulating cover plate; the insulating cover plate comprises at least two first through holes, and the first conductive electrode and the second conductive electrode are disposed in the at least two first through holes, respectively.

4. The electronic cigarette of claim 3, wherein the base comprises a through hole; the conductive pin of the electric heating element extends through the through hole and is electrically connected to the circuit control board.

5. The electronic cigarette of claim 3, further comprising a battery module; wherein the battery module comprises a battery, a third conductive electrode, and a fourth conductive electrode; the battery comprises a first electrode and a second electrode; the third conductive electrode and the fourth conductive electrode are electrically connected to the first electrode and the second electrode, respectively; and the third conductive electrode and the fourth conductive electrode are respectively electrically connected to the first conductive electrode and the second conductive electrode in a contact manner.

6. The electronic cigarette of claim 5, wherein the third conductive electrode and the fourth conductive electrode extends into corresponding first through holes, respectively; and the third conductive electrode and the fourth conductive electrode are respectively electrically connected to the first conductive electrode and the second conductive electrode in the corresponding first through holes in a contact manner.

7. The electronic cigarette of claim 6, wherein one end of the third conductive electrode is electrically connected to the first electrode of the battery, and the third conductive electrode extends along an outer wall of the battery to a top of the battery and enters one of the first through holes; one end of the fourth conductive electrode is electrically connected to the second electrode of the battery, and the fourth conductive electrode extends out of the top of the battery and enters another first through hole; the third conductive electrode and the fourth conductive electrode are both electrode sheets or electrode columns in a bent shape, and the third conductive electrode and the fourth conductive electrode are respectively electrically connected to the first electrode and the second electrode in a contact manner or in a soldering manner.

8. The electronic cigarette of claim 5, wherein the battery module comprises a housing, and the battery is disposed in the housing; the housing comprises a cavity above the battery; the third conductive electrode and the fourth conductive electrode extend into the cavity, and the bottom of the atomization assembly is disposed in the cavity.

9. The electronic cigarette of claim 3, wherein the atomization assembly comprises an e-liquid storage element, a mouthpiece, and a smoke tube; the mouthpiece comprises an inhaling hole; the e-liquid storage element comprises an e-liquid chamber; e-liquid in the e-liquid chamber flows to the electric heating element via an e-liquid inlet; and one end of the smoke tube is connected to the mouthpiece and the other end extends to communicate with the electric heating element.

10. The electronic cigarette of claim 9, wherein the electric heating element comprises an e-liquid guide configured to guide the e-liquid from the e-liquid inlet to the electric heating element.

11. The electronic cigarette of claim 9, wherein the e-liquid storage element comprises a sealing element to seal the e-liquid chamber; and the base is disposed on one side of the sealing element back against the e-liquid chamber.
